(19) United States
(12) Patent Application Publication
(10) Pub. No.: US 2017/0361183 A1
(43) Pub. Date: Dec. 21, 2017

(54) GOLF TEE RECYCLING TOOL

(71) Applicant: THOMAS RUSSEL MCEWEN, West Kelowna (CA)

(72) Inventor: THOMAS RUSSEL MCEWEN, West Kelowna (CA)

(21) Appl. No.: 15/187,808

(22) Filed: Jun. 21, 2016

(51) Int. Cl. A63B 57/00; B26B 27/00

(52) U.S. Cl. CPC A63B 57/0032; B26B 27/00

(57) ABSTRACT

A golf tee recycling tool can include a body, a first aperture, and at least one guillotine blade. The body can be centered on a longitudinal axis and extend along the longitudinal axis between a first end and a second end opposite to the first end along the longitudinal axis. The first aperture can be disposed at the first end and can be sized to slidably receive a shank of a golf tee and substantially maintain the shank centered on the longitudinal axis. The guillotine blade can be disposed in the body and can have at least one edge extending transverse to the longitudinal axis. The guillotine blade can be movable relative to the body between a first position spaced from the longitudinal axis and a second position in which the longitudinal axis passes through the guillotine blade.

### BACKGROUND

### 1. Field

The present disclosure relates to a cutting implement that is hand manipulable and is configured to encircle a rod-like structure, such as the shank of a golf tee.

### 2. Description of Related Prior Art

U.S. Pat. No. 3,911,577 discloses a golf tee sharpener. The device is alleged to be a handy pocket device. The device has an inclined socket, and a vertical way containing a thumb actuated plunger provided with a sharp edge for safely and neatly shearing off the ground end portion of a used golf tee inserted in the socket.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A golf tee recycling tool can include a body, a first aperture, and at least one guillotine blade. The body can be centered on a longitudinal axis and extend along the longitudinal axis between a first end and a second end opposite to the first end along the longitudinal axis. The first aperture can be disposed at the first end and can be sized to slidably receive a shank of a golf tee and substantially maintain the shank centered on the longitudinal axis. The at least one guillotine blade can be disposed in the body and can have at least one edge extending transverse to the longitudinal axis. The at least one guillotine blade can be movable relative to the body between a first position spaced from the longitudinal axis and a second position in which the longitudinal axis passes through the at least one guillotine blade.

### BRIEF DESCRIPTION OF THE DRAWINGS

The detailed description set forth below references the following drawings:

FIG. 1 is a perspective view of a golf tee recycling tool according to an exemplary embodiment of the present disclosure;

FIG. 2 is a partial cross-section of the golf tee recycling tool shown in FIG. 1 taken along section lines 2-2 in FIG. 1;

FIG. 3 is a cross-section of the golf tee recycling tool shown in FIG. 1 taken along section lines 3-3 in FIG. 1;

FIG. 4 is a partial cross-section of the golf tee recycling tool shown in FIG. 1 taken along section lines 4-4 in FIG. 1; and

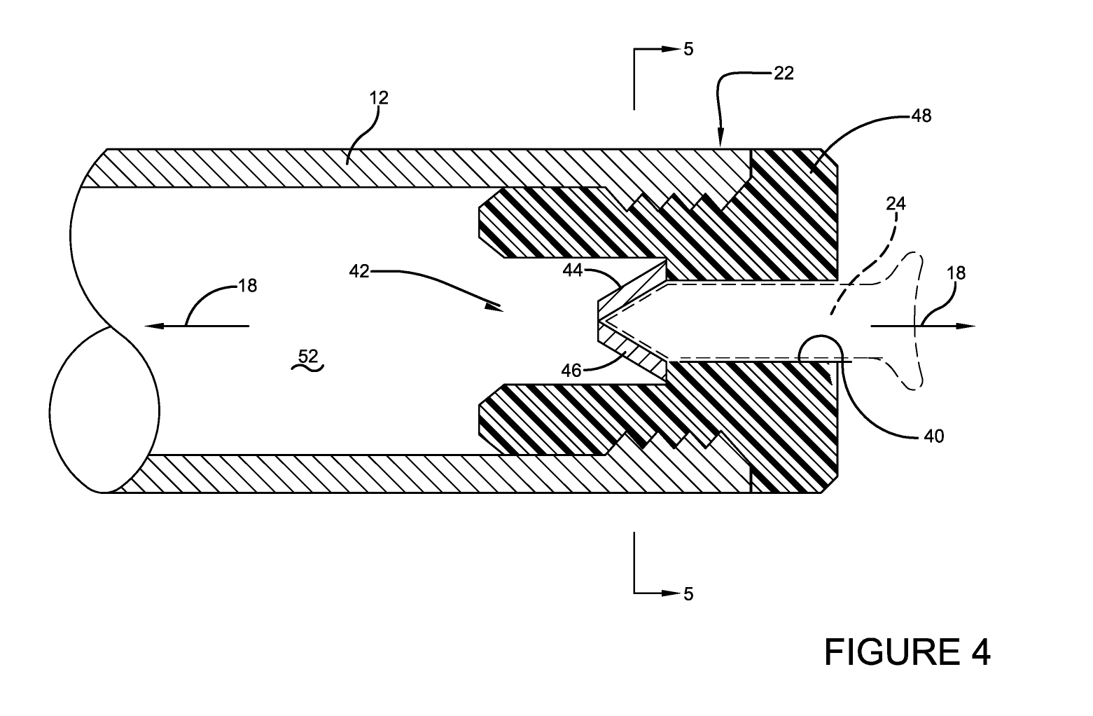

FIG. 5 is a cross-section of the golf tee recycling tool shown in FIG. 1 taken along section lines 5-5 in FIG. 1.

### DETAILED DESCRIPTION

The present disclosure, as demonstrated by the exemplary embodiments described below, can provide a golf tee recycling tool for wooden or plastic tees. The golf tee recycling tool can resize tees by cutting broken or split ends off. The golf tee recycling tool can have built in sharpener to re-sharpen an end for reuse. The golf tee recycling tool will allow the golfer to reuse a portion of their tees and assist in keeping tee boxes free of broken tees. The golf tee recycling tool can be compact. The golf tee recycling tool can have two functions 1) cut tees to resized, usable length and 2) sharpen the blunt end. The golf tee recycling tool will provide the golfer the opportunity to reuse his golf tee or any other tee left on the tee box. This will assist in cleaning up used tees strewn about on tee boxes on golf courses and driving ranges. In recent years, 2.8 billion wood tees were used in the United States, corresponding to the consumption of 70,000 trees per year. The golf tee recycling tool could significantly reduce this number.

A golf tee recycling tool 10 can include a body 12, a first aperture 14, and at least one guillotine blade 16. The body 12 can be centered on a longitudinal axis 18 and extend along the longitudinal axis 18 between a first end 20 and a second end 22 opposite to the first end 20 along the longitudinal axis 18. The body 12 can be formed from plastic or non-ferrous metal, and can be substantially cylindrical. The length of the body 12 along the longitudinal axis 18 can be selected so that the golf tee recycling tool 10 can easily fit in a pocket of a golf bag, such as three to six inches. The diameter of the body 12 perpendicular to the longitudinal axis 18 can be also selected so that the golf tee recycling tool 10 can easily fit in a pocket of a golf bag, such as one-half to two inches.

The first aperture 14 can be disposed at the first end 20 and can be sized to slidably receive a shank 24 of a golf tee 26 (shown in phantom). The first aperture 14 can be sized to substantially maintain the shank 24 centered on the longitudinal axis 18. In other words, the size of the first aperture 14 is slightly larger than the diameter of the shank 24 of a golf tee 26 so that the golf tee 26 can be received, but the shank 24 of the golf tee 26 is substantially maintained as centered on the longitudinal axis 18.

The at least one guillotine blade 16 can be disposed in the body 12. The at least one guillotine blade 16 can have at least one edge 28 extending transverse to the longitudinal axis 18. The at least one guillotine blade 16 can be movable relative to the body 12 between a first position spaced from the longitudinal axis 18 and a second position in which the longitudinal axis 18 passes through the at least one guillotine blade 16. The edge 28 of the at least one guillotine blade 16 extends perpendicular to the longitudinal axis 18.

In the exemplary embodiment, the guillotine blade 16 includes the edge 28 and also a second edge 30. The edges 28, 30 can be arranged transverse to one another, forming a v-shape. The exemplary edges 28, 30 can be integrally-formed with respect to one another. “Integrally-formed” refers to the fact that in the exemplary embodiment the edges 28, 30 are formed together rather than being formed separately and then subsequently joined. The term defines a structural feature since structures that are integrally-formed are structurally different than structures that are comprised of subcomponents formed separately and then subsequently joined. “Integral” means consisting or composed of parts that together constitute a whole and thus encompasses structures of more than one part wherein the parts are either integrally-formed or formed separately and then subsequently joined.

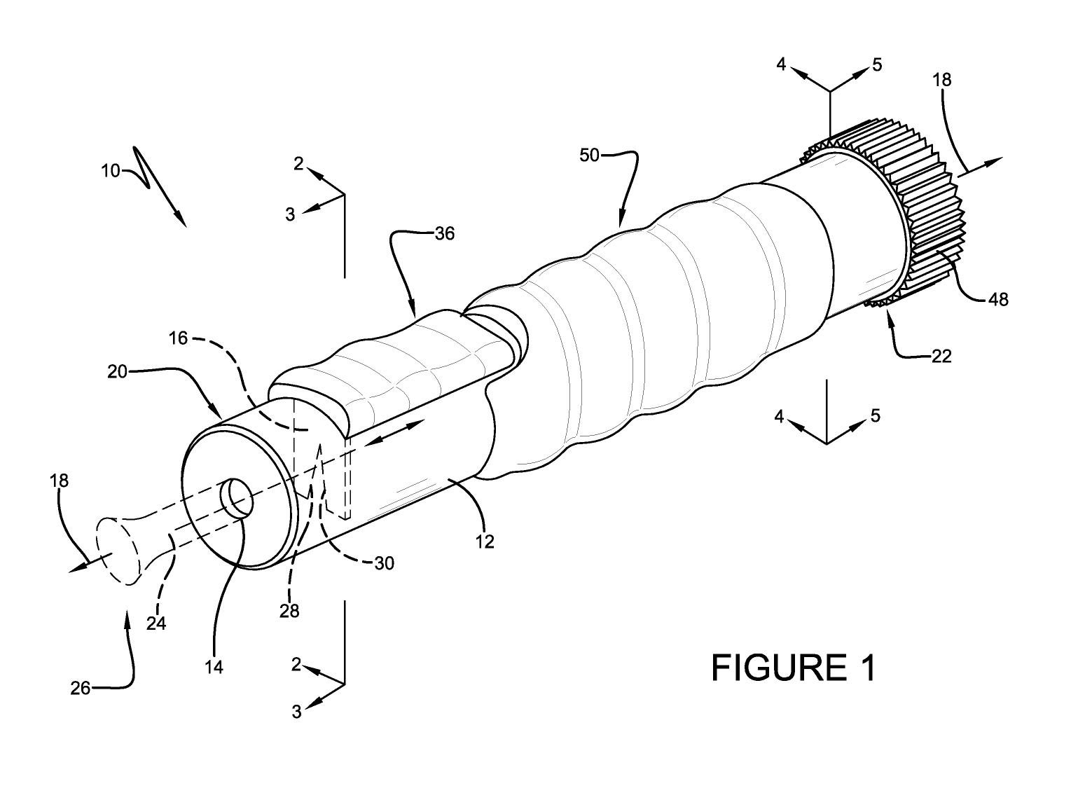

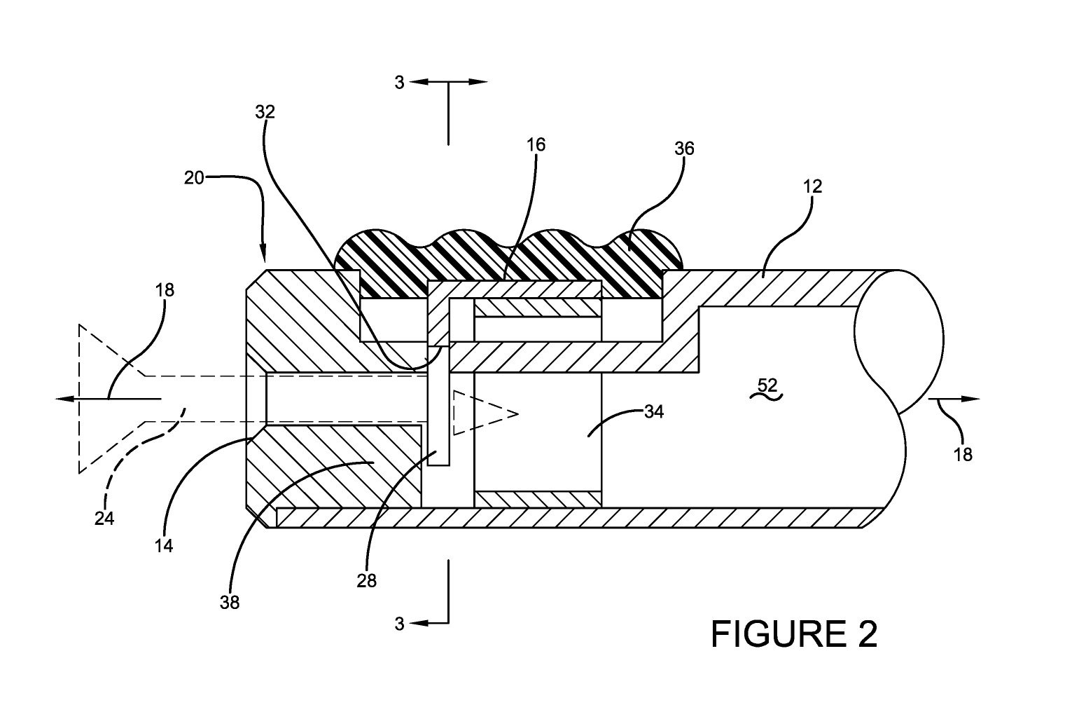

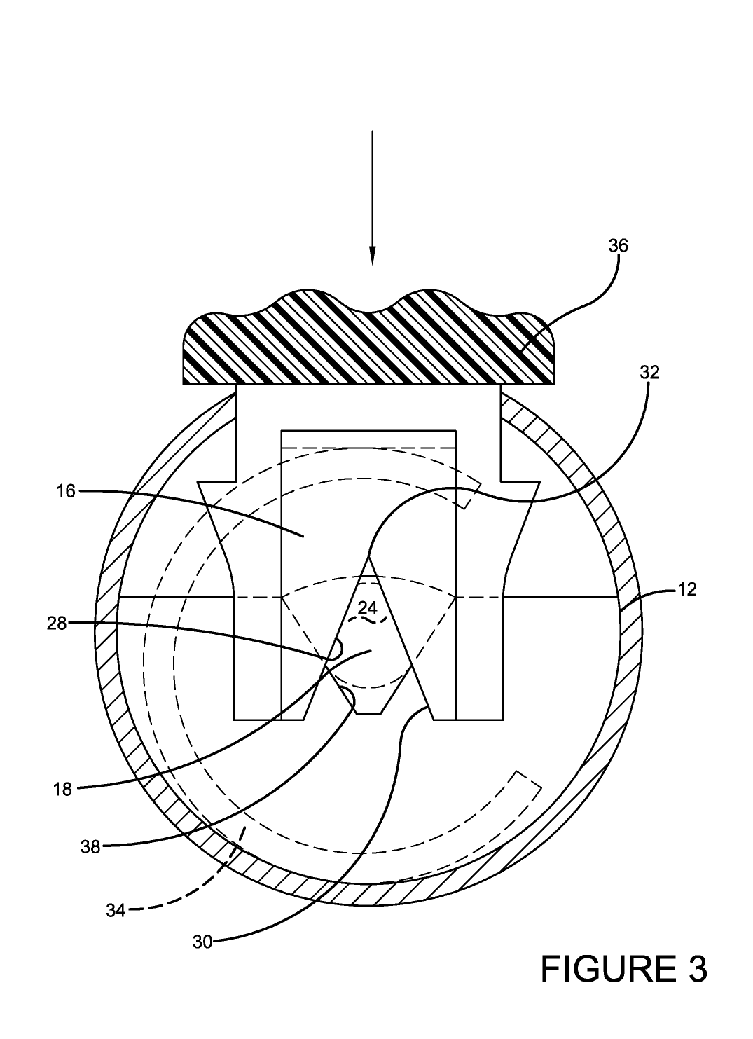

The exemplary edges 28, 30 are mirrored with respect to one another across a plane containing the longitudinal axis 18. This plane would be a vertical plane in FIG. 1, containing the longitudinal axis 18 and the section lines 3-3 and 5-5. The edges 28, 30 intersect one another at an intersection point 32 in the plane (referenced in FIGS. 2 and 3).

The golf tee recycling tool 10 can also include a spring 34. The spring 34 can bias the at least one guillotine blade 16 to the first position. When the at least one guillotine blade 16 is in the first position, the shank 24 can be inserted in the first aperture and extend past the guillotine blade 16 along the longitudinal axis 18. The exemplary spring 34 can be c-shaped and partially encircle the longitudinal axis 18. It is noted that the spring 34 has been added in phantom to FIG. 3 to show its shape; the spring 34 would not be viewable based on the direction of section lines 3-3 and the location of the plane indicated by the section lines 3-3.

The golf tee recycling tool 10 can also include a cover 36. The cover 36 can be movably mounted on the body 12 and be in contact with the at least one guillotine blade 16. A user can press the cover 36 and move the cover 36 against the biasing force of the spring 34, moving the cover 36 relative to the body 12 and thereby moving the at least one guillotine blade 16 from the first position to the second position.

The golf tee recycling tool 10 can also include an anvil 38. The anvil 38 can be disposed in the body 12 substantially immediately adjacent to the at least one guillotine blade 16 along the longitudinal axis 18. The shank 24 of the golf tee 26 can be supported in substantial alignment with the longitudinal axis 18 by the anvil 38. When the at least one guillotine blade 16 moves from the first position to the second position to cut the shank 24, the anvil 38 can maintain the shank 24 in place during the cutting stroke. A common structure can define the anvil 38 and the first aperture 14.

The golf tee recycling tool 10 can also include a second aperture 40. The second aperture 40 can be disposed at the second end 22. Like the first aperture 14, the second aperture 40 can be sized to slidably receive the shank 24 of the golf tee 26. The second aperture 40 can be centered on the longitudinal axis 18.

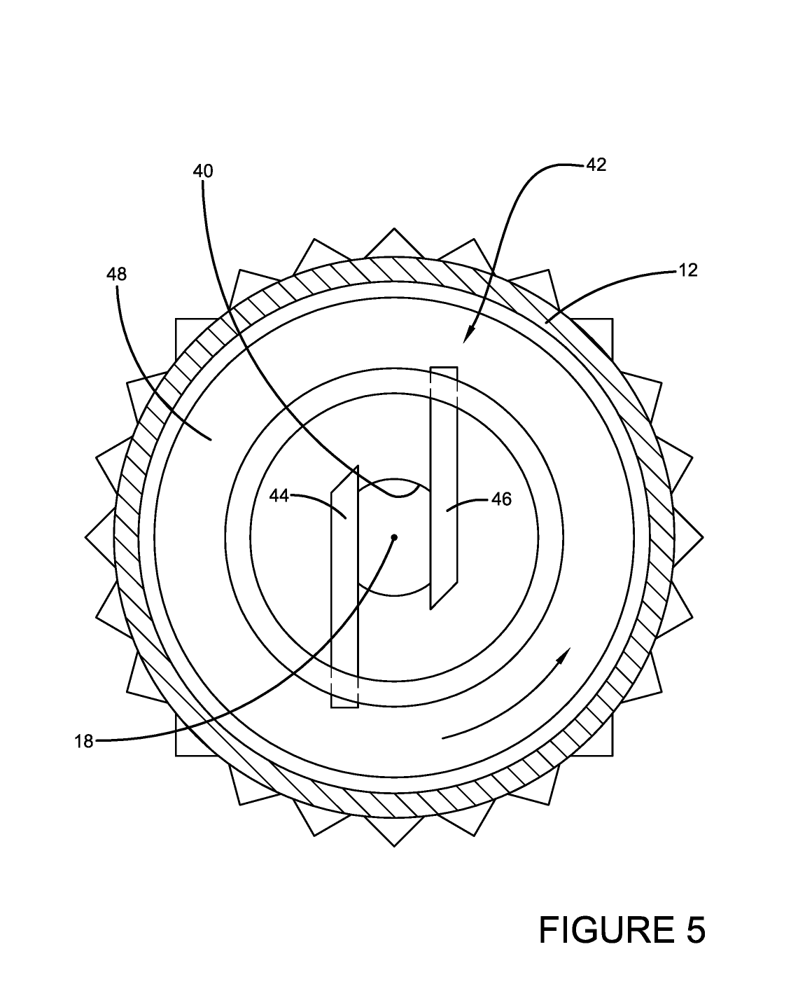

The golf tee recycling tool 10 can also include at least one sharpening blade 42 disposed in the body 12. The sharpening blade 42 can have at least one edge 44 extending both transverse to the longitudinal axis 18 and along the longitudinal axis 18. In other words, the edge 44 extends along and toward the longitudinal axis 18, as shown in FIG. 5. The edge 44 is transverse to the edges 28, 30 of the guillotine blade 16.

The sharpening blade 42 can also include a second edge 46 arranged in mirrored relation to the edge 44. Both of the edges 44 and 46 can extend toward one another along the longitudinal axis 18, in the direction from the second end 22 toward the first end 20. The edges 44, 46 can engage the shank 24 in the same way as the blade or blades of a pencil sharpener engage a pencil shank.

The golf tee recycling tool 10 can also include a cap 48. The cap 48 can be releasibly engaged with the body 12 at the second end 22. The cap 48 can define the second aperture 40. The cap 48 can be engaged with the body 12 through complementary threads on the cap 48 and the body 12. The anvil 38 can be spaced from the cap 48 along the longitudinal axis 18. The spring 34 is positioned closer to the cap 48 than the guillotine blade 16 along the longitudinal axis 18. The sharpening blade 42 can be mounted in the cap 48; the cap 48 can be molded around the blade 42.

The golf tee recycling tool 10 can also include a gripping portion 50. The gripping portion 50 can project away from an outer surface of the body 12. The gripping portion 50 can be rubber or an elastomer and can be contoured to be easily graspable. The gripping portion 50 can be grasped from either direction, when the user is blunting the shank 24 with the guillotine blade 16 or sharpening the shank 24 with the sharpening blade 42.

The body 12 defines a cavity 52 between the first end 20 and the second end 22. The cavity 52 is substantially closed by the anvil 38 and the cap 48. Material removed from the shank 24 of the golf tee 26 by the at least one guillotine blade 16 and material removed by the shank 24 of the golf tee 26 by the at least one sharpening blade 42 can be retained in the cavity 52. The cap 48 can be easily unscrewed from the body 12 to release the material removed from shanks over time.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. The right to claim elements and/or sub-combinations that are disclosed herein as other present disclosures in other patent documents is hereby unconditionally reserved.

What is claimed is:

1. A golf tee recycling tool comprising:
a body centered on a longitudinal axis and extending along said longitudinal axis between a first end and a second end opposite to said first end along said longitudinal axis;
a first aperture disposed at said first end and sized to slidably receive a shank of a golf tee and substantially maintain the shank centered on the longitudinal axis; and
at least one guillotine blade disposed in said body and having at least one edge extending transverse to said longitudinal axis, said at least one guillotine blade movable relative to said body between a first position spaced from said longitudinal axis and a second position in which said longitudinal axis passes through said at least one guillotine blade.

2. The golf tee recycling tool of claim 1 further comprising:
a spring biasing said at least one guillotine blade to said first position.

3. The golf tee recycling tool of claim 2 wherein said spring is c-shaped and partially encircles said longitudinal axis.

4. The golf tee recycling tool of claim 1 further comprising:
a cover movably mounted on said body and in contact with said at least one guillotine blade whereby a user can press said cover and move said cover relative to said body and thereby move said at least one guillotine blade from said first position to said second position.

5. The golf tee recycling tool of claim 1 wherein said at least one edge is further defined as a first edge and a second edge arranged transverse to one another.

6. The golf tee recycling tool of claim 5 wherein said first edge and said second edge are integrally-formed with respect to one another.

7. The golf tee recycling tool of claim 5 wherein said first edge and said second edge are mirrored with respect to one another across a plane containing said longitudinal axis.

8. The golf tee recycling tool of claim 7 wherein said first edge and said second edge intersect one another at an intersection point in said plane.

9. The golf tee recycling tool of claim 1 further comprising:
an anvil disposed in said body substantially immediately adjacent to said at least one guillotine blade along said longitudinal axis whereby the shank of the golf tee is supported in substantial alignment with said longitudinal axis by said anvil when said at least one guillotine blade moves from said first position to said second position and thereby cuts the shank.

10. The golf tee recycling tool of claim 1 further comprising:
a second aperture disposed at said second end and sized to slidably receive the shank of the golf tee; and
at least one sharpening blade disposed in said body and having at least one edge extending both transverse to said longitudinal axis and along said longitudinal axis, said at least one edge of said at least one sharpening blade transverse to said at least one edge of said guillotine blade.

11. The golf tee recycling tool of claim 10 wherein said second aperture is centered on said longitudinal axis.

12. The golf tee recycling tool of claim 10 wherein said at least one edge of said at least one sharpening blade is further defined as a first edge and a second edge arranged in mirrored relation to one another.

13. The golf tee recycling tool of claim 10 wherein further comprising:
a cap releasibly engaged with said body at said second end, said cap defining said second aperture.

14. The golf tee recycling tool of claim 13 wherein said at least one sharpening blade is mounted in said cap.

15. The golf tee recycling tool of claim 14 further comprising:
an anvil disposed in said body engaged with said body at said first end, said anvil defining said first aperture and spaced from said cap along said longitudinal axis.

16. The golf tee recycling tool of claim 15 wherein said body defines a cavity between said first end and said second end, said cavity substantially closed by said anvil and said cap, material removed from the shank of the golf tee by said at least one guillotine blade and material removed by the shank of the golf tee by said at least one sharpening blade retained in said cavity.

17. The golf tee recycling tool of claim 16 wherein at least one edge of said at least one guillotine blade extend perpendicular to said longitudinal axis.

18. The golf tee recycling tool of claim 17 wherein said cap is engaged with said body through complementary threads on said cap and said body.

19. The golf tee recycling tool of claim 18 further comprising:
a spring biasing said at least one guillotine blade to said first position and partially encircling said longitudinal axis, wherein said spring is positioned closer to said cap than said at least one guillotine blade along said longitudinal axis.

20. The golf tee recycling tool of claim 19 further comprising:
a gripping portion projecting away from an outer surface of said body.
